(19) United States
(12) Patent Application Publication
(10) Pub. No.: US 2024/0127699 A1
(43) Pub. Date: Apr. 18, 2024

(54) APPARATUS AND METHOD FOR CALCULATING ANTICIPATED ENERGY CONSUMPTION FOR ELECTRIC AIRCRAFT

(71) Applicant: BETA AIR, LLC, South Burlington, VT (US)

(72) Inventor: Timothy Gerard Richter, South Burlington, VT (US)

(73) Assignee: BETA AIR, LLC, South Burlington, VT (US)

(21) Appl. No.: 17/966,164

(22) Filed: Oct. 14, 2022

(51) Int. Cl. G08G 5/00; B64C 29/00; B64D 27/24; G06N 20/00

(52) U.S. Cl. CPC G08G 5/0034; B64C 29/00; B64D 27/24; G06N 20/00

(57) ABSTRACT

An apparatus and method for calculating anticipated energy consumption for electric aircraft are disclosed. The method may include receiving flight plan data and determining at least a flight phase as a function of the flight plan data. Further, the method may include estimating a duration and energy consumption rate for the at least a flight phase, estimating a usable energy capacity of the electric aircraft, and determining a value of additional energy to add to the electric aircraft.

### FIELD OF THE INVENTION

The present invention generally relates to the field of electric aircraft. In particular, the present invention is directed to an apparatus and method for calculating anticipated energy consumption for electric aircraft.

### BACKGROUND

Managing usable energy capacity for an electric aircraft may allow for more efficient use of energy capacity with regard to a particular flight plan.

### SUMMARY OF THE DISCLOSURE

In an aspect, a method of calculating anticipated energy consumption for electric aircraft is described. The method includes receiving, by a processor, flight plan data for an electric aircraft and determining, by the processor, at least a flight phase as a function of the flight plan data. Further, the method may include receiving, by the processor, an indication, wherein the indication comprises a current capacity of at least a usable energy storage element of the electric aircraft. The method includes estimating, by the processor, a usable energy capacity of the electric aircraft, wherein estimating the usable energy capacity includes training a usable energy capacity machine learning model as a function of usable energy capacity training data, inputting the flight plan data to the usable energy capacity machine learning model, and outputting the usable energy capacity as a function of the flight plan data and the usable energy capacity machine learning model. The method also includes determining, by the processor, a value of additional energy to be added to the electric aircraft as a function of the flight plan data, the current capacity of at least a usable energy storage element, and the usable energy capacity.

In another aspect, an apparatus for calculating anticipated energy consumption for electric aircraft, the apparatus including at least a processor and a memory communicatively connected to the at least a processor, the memory containing instructions configuring the at least a processor to receive flight plan data for an electric aircraft. The memory further including instructions configuring the processor to determine at least a flight phase as a function of the flight plan data. The memory further including instructions configuring the processor to receive an indication, wherein the indication includes a current capacity of at least a usable energy storage element of the electric aircraft. The memory further including instructions configuring the processor to estimate a usable energy capacity of the electric aircraft, wherein estimating the usable energy capacity includes training a usable energy capacity machine learning model as a function of a usable energy capacity training data, inputting the flight plan data to the usable energy capacity machine learning model, and outputting the usable energy capacity as a function of the flight plan data and the usable energy capacity machine learning model. The memory further including instructions configuring the processor to determine a value of additional energy to be added to the electric aircraft as a function of the flight plan data, a current energy amount of the electric aircraft, and the usable energy capacity.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an energy management system in accordance with one or more embodiments of the present disclosure;

FIG. 2 is a block diagram of an exemplary embodiment of a power management system incorporated into an electric aircraft in accordance with one or more embodiments of the present disclosure;

FIG. 3 is an illustration of an exemplary embodiment of an electric aircraft in accordance with one or more embodiments of the present disclosure;

FIG. 4 is flow diagram of an exemplary method of calculating anticipated energy consumption for an electric aircraft in accordance with one or more embodiments of the present disclosure;

FIG. 5 is a block diagram of an exemplary flight controller in accordance with one or more embodiments of the present disclosure;

FIG. 6 is a block diagram of an exemplary embodiment of a machine-learning module in accordance with one or more embodiments of the present disclosure; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to managing reserve energy for an electric aircraft fleet. For example, and without limitation, managing reserve energy may include using machine learning to determine amounts of fuel associated with various phases of a flight plan. In one or more embodiments, aspects of the present disclosure can be used to sense a current amount of fuel in one or more electric aircrafts of an electric aircraft fleet. Further, machine learning may use a current value of available energy, a particular pilot, a flight plan, or any parameter of the like to determine a necessary amount of reserve energy for each electric aircraft. Thus, enabling more efficient use of energy for each aircraft of an electric aircraft fleet. to Exemplary embodiments illustrating aspects of the present disclosure are described below in the context of several specific examples.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

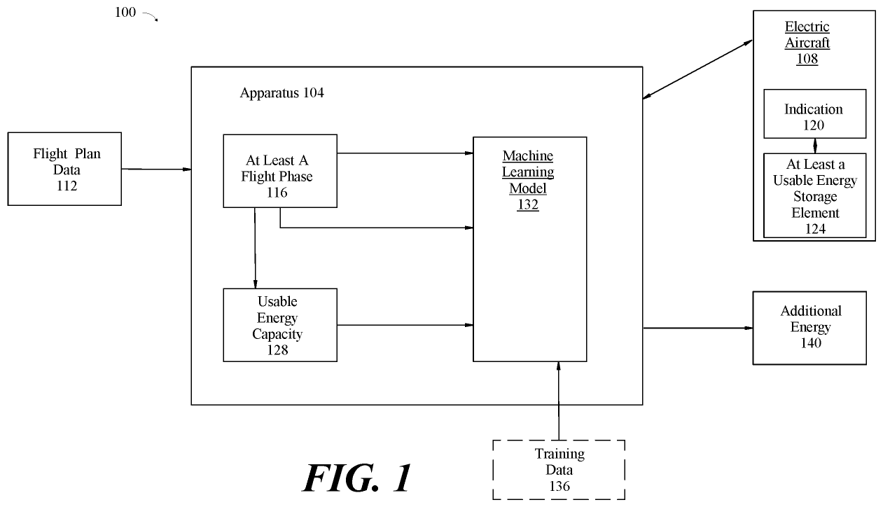

Now referring to FIG. 1, a block diagram of an energy management system 100 is shown. Energy management system 100 may include an apparatus 104 for calculating anticipated energy consumption for an electric aircraft 108. Apparatus 104 includes at least a processor. The processor may be consistent with any processor discussed in this disclosure. In some embodiments, electric aircraft 108 may be an electric vertical takeoff and landing (eVTOL) aircraft. For example, electric aircraft may perform a vertical takeoff maneuver while departing and a hover landing upon arrival. Electric aircraft 108 may include components described in further detail below.

With continued reference to FIG. 1, apparatus 104 includes a memory communicatively connected to at least a processor, wherein the memory contains instructions configuring the processor to perform tasks in accordance with this disclosure. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

In some embodiments, apparatus 104 may receive flight plan data 112 for electric aircraft 108. As described herein, “flight plan data” is at least an element of readable data that includes information relating to, or describing, a flight plan. A “flight plan,” as used herein, is a planned route or flight path for an electric aircraft. In some embodiments, a flight plan may include other information associated with the route or flight path. In an embodiment, the flight plan may be created by the pilot. In other embodiments, flight plan may be created by an external party, such as a fleet manager. In other embodiments, flight plan may be generated by a computing device. In a nonlimiting example, flight plan may be created by a pilot based on the terrain and areas with high flight traffic. Flight plan data 112 may include a plurality of variables including, without limitation, a takeoff location, a time of anticipated takeoff, landing location, an estimated time of landing, a route, trajectory and speed of travel, and/or weather datum. As used in this disclosure, “weather datum” is an element of data of current weather conditions and/or future weather forecasts of locations along and/or near a route in a flight plan. For example, weather datum may include a weather forecast of a location at a specified future time that flight plan 120 includes in a route for electric aircraft 108 to fly over at that specified time. Flight plan data 112 may include information related to an immediately preceding flight plan. An “immediately preceding flight plan,” as used herein, is a flight plan for the electric aircraft 108 that has been concluded. In a nonlimiting example, flight plan data 112 may include information related to an immediately preceding flight plan to be used when the electric aircraft is returning to its original location, such as a home airport. Weather datum may be received by a controller from a local sensor on electric aircraft 108, a computing device transmitting weather information, and/or user input. Flight plan data 112 may include payload information such as the weight of cargo and/or the number of passengers in electric aircraft 108. Flight plan data 112 may include information regarding a battery pack. For example, flight plan data 112 may include a quantity of a battery pack in electric aircraft 108, the make and model of each battery pack, the state of charge of each battery pack, current temperature of a battery pack, and any recorded data concerning each battery pack such as past phenomena or incidents of each battery pack. State of charge may be implemented as disclosed in U.S. patent application Ser. No. 17/349,182 filed on Jun. 16, 2021 and entitled “SYSTEMS AND METHODS FOR IN-FLIGHT OPERATIONAL ASSESSMENT”, the entirety of which in incorporated herein by reference. For example, and without limitations, flight plan data 112 may include a date, a time, a starting location, an ending location, one or more intermediate stops, total hover time, total cruising time, weather data, an aircraft model, an aircraft serial number, a crew, a cargo, or any combination thereof. Further, flight plan data 112 may include data specific to a particular pilot scheduled to operated electric aircraft 108.

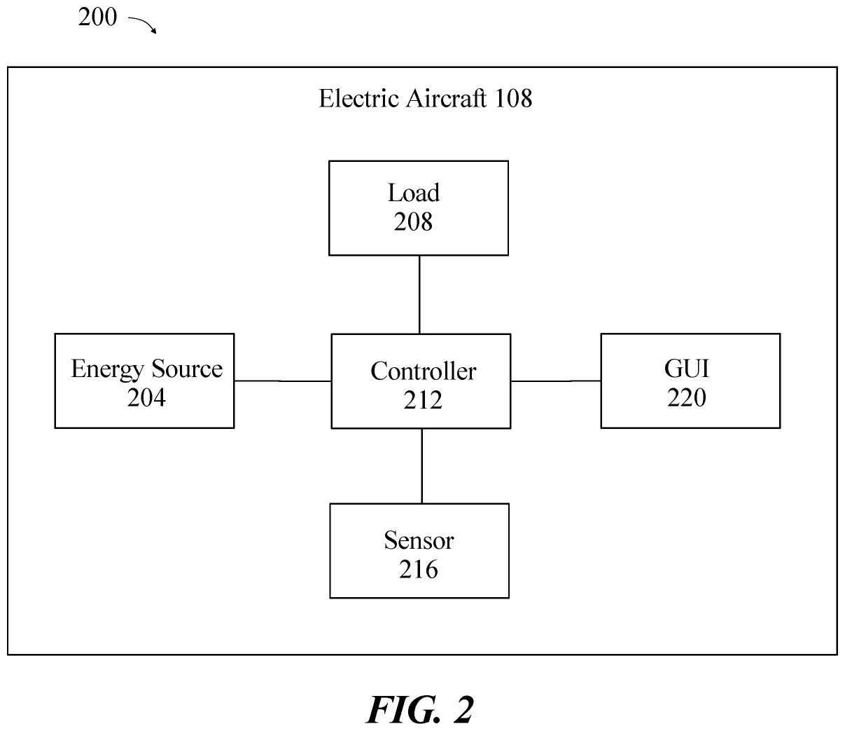

Still referring to FIG. 1, apparatus 104 may determine at least a flight phase 116 as a function of flight plan data 112. As described herein, a “flight phase” is a maneuver or plurality of maneuvers that is performed by electric aircraft 108. For example, at least a flight phase 116 may include taxiing, hovering, cruising, take-off, landing, or any combination thereof. That is, at least a flight phase 116 is a maneuver performed by electric aircraft 108 that requires the use of energy from the electric aircraft 108. In an embodiment, at least a flight phase 116 may be a horizontal phase. As used in this disclosure, “horizontal phase” may include cruising, taxiing, gliding and the like. In some embodiments, at least a flight phase may be a vertical phase. As used in this disclosure, “vertical phase” may include a vertical takeoff, hover landing, hover flight, and the like. At least a flight phase may include a transition phase. As used in this disclosure, “transition phase” is the transition between hover flight and fixed-wing flight and from fixed-wing flight to hover flight. It should be noted that at least a flight phase 116 may be determined from various parameters included in flight plan data 112. In some embodiments, apparatus 104 may modify at least a flight phase 116 based on a change in at least one of parameter of flight plan data 112. For example, flight plan data 112 may indicate a weather change for a scheduled flight. As such, apparatus 104 may modify at least a flight phase 116 to accommodate the weather change. To do this, apparatus 104 may receive an indication 120 indicating a current capacity of at least a usable energy storage element 124. Energy source is described in detail in FIG. 2.

Continuing to refer to FIG. 1, apparatus 104 may receive indication 120 from electric aircraft 108 of a current capacity of at least a usable storage element 124. As described herein, “current capacity” is the amount of energy stored in at least a usable storage element 124. For example, current capacity of at least a usable storage element may be twenty-five percent, fifty percent, seventy-five percent, or any percentage between zero and one hundred. In some instances, current capacity of at least a usable storage element 124 may be denoted in terms of state of health (SoH) percentages. In some instances, current capacity of at least a usable storage element 124 may be denoted in terms of state of charge (SoC) percentages. Indication 120 may transmit to apparatus 104 via any suitable network connection such as Wi-Fi, BLUETOOTH, local area network (LAN), wired connection, any connection of the like. It should be noted that indication 120 may be transmitted before, during, or after operation of electric aircraft 108. In some embodiments, apparatus 104 may be housed on electric aircraft 108. Although not shown in FIG. 1, it should be appreciated that operations performed by apparatus 104, as described and discussed herein, may be performed on electric aircraft 108 while the electric aircraft 108 is in operation. Performing operations mid-flight may enable electric aircraft to perform various maneuvers in response to receiving indication 120. Continuing an example from the immediately preceding paragraph, at least a flight phase 116 may be changed due to weather change. As such. indication 120 may indicate that there is less available energy in at least a usable energy storage element 124 in order to preserve reserve fuel. For clarity, and to continue the non-limiting example, when flight phase 116 changes, indication 120 may change in response to the change in flight phase 116. However, current capacity of at least a usable storage element 124 may not physically change. Only the indication 120 will change to provide a pilot or operator with more accurate information while preserve reserve energy.

Still referring to FIG. 1, apparatus 104 may estimate a usable energy capacity 128 of electric aircraft 108. A “usable energy capacity,” as used in this disclosure, is the portion of the total energy capacity of an energy source that can be used by the aircraft in normal operations. In an embodiment, usable energy capacity may be represented as

Usable energy capacity=Depth of discharge %*Nominal capacity.

A “Depth of discharge %”, as used herein, refers to the amount of energy that is cycled into and out of an energy source on a given cycle, where the depth of discharge is represented as a percentage of the total capacity of the energy source. A “Nominal capacity,” as used herein, is the amount of energy that can be withdrawn from the energy source at a particular constant current, starting from a fully charged state. This may be done using a machine learning algorithm. In some instances, a usable energy capacity machine learning model 132 may be trained as a function of usable energy capacity training data 136. Training data 136 may correlate historical flight plan data to usable energy capacity data. Once usable energy capacity machine learning model 132 is trained using training data 136, flight plan data 112 may be inputted into the machine learning model 132. An estimate of usable energy 128 may be outputted as a function of flight plan data 116 and usable energy capacity machine learning model 132. As mentioned above, these operations may be performed mid-flight in efforts to preserve reserve energy. In some instances, these operations may be performed pre-flight and/or post-flight. In those instances, there may be an opportunity to add additional energy 140 to at least a usable energy storage element 124 to ensure that each phase of at least a flight phase 116 is carried out.

Still referring to FIG. 1, apparatus 104 may determine a value of additional energy 140 to be added to electric aircraft 108 as a function of flight plan data 112, current capacity of at least a usable energy storage element 124, and usable energy capacity 128. In a nonlimiting example, the value of additional energy is determined based on flight plan data, such as total time of hovering and cruising, the capacity of the battery in the electric aircraft 108 and the usable energy capacity of the electric aircraft 108. In an embodiment, determining the value of additional energy may include an additional energy machine learning model. In an embodiment, additional energy machine learning model may be trained using additional energy training data. Additional energy training data, may include past historical data related to past determinations of additional energy requirements correlated to past flights, which may include flight data plan 112, usable capacity 128 and capacity of at least a usable energy storage element 124 for each of those past flights. The additional energy machine learning model may be configured to receive a flight plan data 112, usable energy capacity 128, and/or current energy capacity of at least a usable energy storage element 124 as inputs and output a value of additional energy 140. In some embodiments, determining the value of additional energy may include determining the value as a function of a particular pilot. As a nonlimiting example, a particular pilot may have a flight plan that differs from another pilot, which apparatus 100 considers in determining the value of additional energy. In another nonlimiting example, one pilot's flight style may be less energy efficient than other pilots, which apparatus 100 considers in determining the value of additional energy. Additional energy machine learning model maybe be trained and generated according to any embodiments provided in this disclosure.

Now referring to FIG. 2, a block diagram of a power management system 200 incorporated into electric aircraft 108 is illustrated. Power management system 200 may be configured to sense a current usable energy capacity and determine whether there is enough energy to complete a flight plan based at least on the current usable energy capacity and the specific flight plan. In some instances, power management system 200 may use additional parameters, such as pilot information, weather data, additional flight plans of additional aircrafts, or the like, to determine whether there is enough energy to complete a flight plan. Power management system 200 may include an energy source 204, a load 208, a controller 212, at least a sensor 216, a graphical user interface (GUI) 220, or any combination thereof. As used in this disclosure, sensor 216 and at least a sensor may be used interchangeably. Power management system 200 may be incorporated in an electric aircraft or any other electrically powered vehicle. In particular, power management system 200 may be incorporated in an electric vertical takeoff and landing (eVTOL) aircraft, as described in further detail below.

Continuing to refer to FIG. 2, electric aircraft 108 may include an energy source 204 which may be mechanically connected to an electric aircraft. As used herein, “mechanically connected” is a process whereby one device, component, or circuit is used to connect two shafts together at their ends for the purpose of transmitting power. In an embodiment, mechanical connections are used to connect the ends of adjacent parts and/or objects of the electric aircraft. In an embodiment, mechanical connections are used to join two pieces of rotating electric aircraft components. As an example and without limitation, mechanical connections may include rigid connections, such as beam connections, bellows connections, bushed pin connections, constant velocity connections, split-muff connections, diaphragm connections, disc connections, donut connections, elastic connections, flexible connections, fluid connections, gear connections, grid connections, hirth connections, hydrodynamic connections, jaw connections, magnetic connections, Oldham connections, sleeve connections, tapered shaft lock, twin spring connections, rag joint connections, universal joints, and the like.

Energy source 204 may provide power to at least a portion of electric aircraft 108. In some embodiments, energy source 204 may be a cell. For example, energy source 204 may include, but not limited to, a generator, a photovoltaic device, a battery cell, a fuel cell (e.g., a hydrogen fuel cell), a direct methanol fuel cell, a solid oxide fuel cell, an electric energy storage device, or the like. An electric energy storage device may include without limitation a capacitor and/or a battery. It should be noted that one of ordinary skill in the art would know that energy source 204 may be designed to meet energy or power requirements of various electric vehicles on which power management system 200 may be integrated. A person of ordinary skill in the art should further appreciate that energy source 204 can be designed to fit within a designated footprint on the various electric aircraft on which power management system 200 may be integrated. In some instances, energy source 204 may be a usable energy storage of an electric vehicle. That is, energy source 204 may store energy for an electric vehicle and may be used to determine a current level of energy capacity, an amount of reserve energy, a maximum energy capacity, or the like.

Still referring to FIG. 2, in an embodiment, energy source 204 may be used to provide consistent electrical power to load 208 during the travel of an electric aircraft, such as during the flight. Energy source 204 may be capable of providing sufficient power for “cruising” and other relatively low-power phases of flight; cruising may consume a portion of usable energy capacity of energy source 204. Further, energy source 204 can also provide electrical power for some higher-power phases of flight as well, particularly when the energy source 204 is at a high state of charge (SOC), as may be the case for instance during takeoff. Energy source 204 may be capable of providing sufficient electrical power for auxiliary loads including without limitation, lighting, navigation, communications, de-icing, steering or other systems requiring power or energy. Energy source 204 may be capable of providing sufficient power for controlled descent and landing protocols, including, without limitation, hovering descent or runway landing. As used herein, an energy source 104 may have high power density wherein the electrical power the energy source can usefully produce per unit of volume, and/or mass, is relatively high. Energy source 204 may include a device for which power that may be produced per unit of volume and/or mass has been optimized, at the expense of the maximal total specific energy density or power capacity, during design.

Continuing to refer to FIG. 2, non-limiting examples of items that may be used as an energy source 104 may include batteries used for starting applications including lithium-ion batteries which may include nickel cobalt aluminum (NCA), nickel manganese cobalt (NMC), lithium iron phosphate (LiFePO4), lithium cobalt oxide (LCO), and/or lithium manganese oxide (LMO) batteries, and the like. In some embodiments, said lithium-ion batteries can be mixed with another cathode chemistry in order to provide more specific power as an application may require. For example, an application may require lithium metal batteries, wherein the lithium metal batteries include a lithium metal anode that provides high power on demand. An application may further require lithium-ion batteries, wherein the lithium-ion batteries have a silicon or titanate anode. In some embodiments, energy source 204 may be used to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation, a battery using nickel-based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology. An energy source 204 may include, without limitation, lead-based batteries such as without limitation lead acid batteries, metal-air batteries, or any other suitable battery. A battery may further include, without limitation, lithium sulfur batteries, magnesium ion batteries, and/or sodium ion batteries. Batteries may include solid state batteries or supercapacitors or another suitable energy source. Batteries may be primary or secondary or a combination of both. Persons skilled in the art, upon reviewing the entirety of this disclosure, will be aware of various devices of components that may be used as energy source 204.

Still referring to FIG. 2, an energy source 204 may be mechanically connected to load 208. Load 208 may be further mechanically connected to a controller 212. Load 208 may be any device or component that consumes electrical power on demand. Load 208 may include one or more propulsive devices, including without limitation one or more propellers, turbines, impellers, or other devices necessary for take-off, propelling or landing the electric aircraft during flight. Energy source 204 may supply power to the propulsive device. Load 208 may be, without limitation, in the form of a propulsive device. A “propulsive device”, as described herein, is a component or device used to propel a craft by exerting force on a fluid medium, which may include a gaseous medium such as air or a liquid medium such as water. A propulsive device, as described herein, may include, without limitation, a thrust element. The thrust element may include any device or component that converts the mechanical energy of a motor, for instance in the form of rotational motion of a shaft, into thrust in a fluid medium. The thrust element may include, without limitation, a device using moving or rotating foils, including without limitation one or more rotors, an airscrew or propeller, a set of airscrews or propellers such as contra-rotating propellers, a moving or flapping wing, or the like. A thrust element may include without limitation a marine propeller or screw, an impeller, a turbine, a pump-jet, a paddle or paddle-based device, or the like.

Still referring to FIG. 2, load 208 may convert electrical energy into kinetic energy; for instance, load 208 may include one or more electric motors. An electric motor, as described herein, is a device that converts electrical energy into mechanical energy, for instance by causing a shaft to rotate. An electric motor may be driven by direct current (DC) electric power. As an example and without limitation, an electric motor may include a brushed DC electric motor or the like. An electric motor may be, without limitation, driven by electric power having varied or reversing voltage levels, such as alternating current (AC) power as produced by an alternating current generator and/or inverter, or otherwise varying power, such as produced by a switching power source. An electric motor may include, for example and without limitation, brushless DC electric motors, permanent magnet synchronous an electric motor, switched reluctance motors, or induction motors. In addition to inverter and/or a switching power source, a circuit driving an electric motor may include electronic speed controllers (not shown) or other components for regulating motor speed, rotation direction, and/or dynamic braking.

With continued reference to FIG. 2, load 208 may convert electrical energy into heat. As an example, and without limitation, load 208 may include resistive loads. As a further example and without limitation, load 208 may convert electrical energy into light. Load 208 may include one or more elements of digital or analog circuitry. For instance, and without limitation, load 208 may consume power in the form of voltage sources to provide a digital circuit's high and low voltage threshold levels, to enable amplification by providing “rail” voltages, or the like. Load 208 may include, as a non-limiting example, control circuits, aircraft controllers and/or controllers as described in further detail below. Energy source 204 may connect to load 208 using an electrical connection enabling electrical or electromagnetic power transmission, including any conductive path from the energy source 204 to the load 208, any inductive, optical or other power connections such as an isolated power connection, or any other device or connection usable to convey electrical energy from an electrical power, voltage, or current source. The electrical connection may include, without limitation, a distribution bus. Persons skilled in the art, upon reviewing the entirety of this disclosure, will be aware of various devices that may be used as a load 208.

Continuing to refer to FIG. 2, power management system 200 may include a controller 212. Controller 212 may include any controller as described in this disclosure, including without limitation a microcontroller, microprocessor, digital signal processor (DSP) and/or system on a chip (SoC) as described in this disclosure. Controller 212 may include, be included in, and/or communicate with a mobile device such as a mobile telephone or smartphone. Controller 212 may include a single controller operating independently, or may include two or more controllers operating in concert, in parallel, sequentially or the like; two or more controllers may be included together in a single controller or in two or more controllers. Controller 212 may interface or communicate with one or more additional devices as described below in further detail via a network interface device. Network interface device may be utilized for connecting controller 212 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two controllers, and any combinations thereof. A network may employ a wired and/or a wireless mode of communication. In general, any network topology may be used. Information (e.g., data, software etc.) may be communicated to and/or from a computer and/or a controller. Controller 212 may include but is not limited to, for example, a controller or cluster of controllers in a first location and a second controller or cluster of controllers in a second location. Controller 212 may include one or more controllers dedicated to data storage, security, distribution of traffic for load balancing, and the like. Controller 212 may distribute one or more computing tasks as described below across a plurality of controllers of controller 212, which may operate in parallel, in series, redundantly, or in any other manner used for distribution of tasks or memory between controllers. Controller 212 may be implemented using a “shared nothing” architecture in which data is cached at the worker, in an embodiment, this may enable scalability of system 200 and/or controller 212.

With continued reference to FIG. 2, controller 212 may be designed and/or configured to perform any method, method step, or sequence of method steps in any embodiment described in this disclosure, in any order and with any degree of repetition. For instance, controller 212 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 212 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 2, controller 212 may be communicatively connected to sensor 216 and load 208. As used herein, “communicatively connecting” is a process whereby one device, component, or circuit is able to receive data from and/or transmit data to another device, component, or circuit; communicative connection may be performed by wired or wireless electronic communication, either directly or by way of one or more intervening devices or components. In an embodiment, communicative connecting includes electrically coupling an output of one device, component, or circuit to an input of another device, component, or circuit. Communicatively connecting may be performed via a bus or other facility for intercommunication between elements of a computing device as described in further detail below in reference to FIG. 10. Communicatively connecting may include indirect connections via “wireless” connection, low power wide area network, radio communication, optical communication, magnetic, capacitive, or optical coupling, or the like. Controller 212 may include any computing device or combination of computing devices as described in detail below in reference to FIG. 10. Controller 212 may include any processor or combination of processors as described below in reference to FIG. 10. Controller 212 may include a microcontroller. Controller may be incorporated in the electric aircraft or may be in remote contact.

Still referring to FIG. 2, controller 212 may be communicatively connected, as defined above, to load 208. As used herein, controller 212 is communicatively connected to the load wherein controller 212 is able to transmit signals to the load and the load is configured to modify an aspect of load behavior in response to the signals. As a non-limiting example, controller 212 may transmit signals to load 208 via an electrical circuit connecting controller 212 to the load 208. As an example, and without limitation, the circuit may include a direct conductive path from controller 212 to the load or may include an isolated coupling such as an optical or inductive coupling. Alternatively or additionally, controller 212 may communicate with load 208 using wireless communication, such as without limitation communication performed using electromagnetic radiation including optical and/or radio communication, or communication via magnetic or capacitive coupling. Persons skilled in the art will be aware, after reviewing the entirety of this disclosure, of many different forms and protocols of communication that may be used to communicatively couple controller 212 to load 208.

In an embodiment and still referring to FIG. 2, controller 212 may include a reconfigurable hardware platform. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform may be reconfigured to enact any algorithm and/or algorithm selection process received from another computing device and/or created using machine-learning and/or neural net processes as described below.

In an embodiment and continuing to refer to FIG. 2, where power management system 200 is incorporated into electric aircraft 108, controller 212 is programmed to operate electronic aircraft to perform a flight maneuver. As described herein, at least a flight maneuver may include takeoff, landing, stability control maneuvers, emergency response maneuvers, regulation of altitude, roll, pitch, yaw, speed, acceleration, or the like during any phase of flight. As an example, and without limitation, at least a flight maneuver may include a flight plan or sequence of maneuvers to be performed during a flight plan. As a further example and without limitation, at least a flight maneuver may include a runway landing. A runway landing, as defined herein, is a landing in which a fixed-wing aircraft, or other aircraft that generates lift by moving a foil forward through air, flies forward toward a flat area of ground or water, alighting on the flat area and then moving forward until momentum is exhausted on wheels or, in the case of landing on water, pontoons; momentum may be exhausted more rapidly by reverse thrust using propulsors, mechanical braking, electric braking, or the like. As a further non-limiting example, a flight maneuver may include a vertical landing protocol (i.e., a vertical fphase). As described herein, “vertical phase,” “vertical landing protocol,” and “vertical takeoff maneuver” are maneuvers and/or flights phases requiring an aircraft to translate in a substantially vertical direction. Vertical landing protocol may include, without limitation, a rotor-based landing, such as one performed by rotorcraft such as helicopters or the like. In an embodiment and without limitation, vertical landing protocols may require greater expenditure of energy than runway-based landings. Vertical landing protocol may, for instance and without limitation, require substantial expenditure of energy to maintain a hover or near-hover while descending, while runway-based landings may, as a non-limiting example, require a net decrease in energy to approach or achieve aerodynamic stall. Controller 212 may be designed and configured to operate electronic aircraft via fly-by-wire.

With continued reference to FIG. 2, controller 212 may direct loads, which may include a load 108, to perform one or more flight maneuvers as described above, including takeoff, landing, and the like. As an example, and without limitation, controller 212 may be configured to perform a partially and/or fully automated flight plan. In an embodiment and without limitation, controller 212 may be configured to command load 208 to increase power consumption, such as to transition to rotor-based flight at aerodynamic stall during a vertical landing procedure or to a runway based controlled descent. In an embodiment and without limitation, controller 212 may determine a moment to send a command to an instrument to measure time, such as a clock, by receiving a signal from one or more sensors, or a combination thereof. As a further example and without limitation, controller 212 may determine, by reference to a clock and/or navigational systems and sensors, that electric aircraft is approaching a destination point, reduce airspeed to approach aerodynamic stall, and may generate a timing-based prediction for the moment of aerodynamic stall to compare to a timer, while also sensing a velocity or other factor consistent with aerodynamic stall before issuing the command. Persons skilled in the art will be aware, upon reviewing the entirety of this disclosure, of various combinations of sensor inputs and programming inputs that controller 212 may use to guide, modify, or initiate flight maneuvers including landing, steering, adjustment of route, and the like.

Still referring to FIG. 2, controller 212 may be communicatively connected to sensor 216. “Sensor”, as described herein, is any device, module, and/or subsystems, utilizing any hardware, software, and/or any combination thereof to detect events and/or changes in the instant environment and communicate the information to a controller. Sensor 216 may monitor the status critical and non-critical functions of power management system 200. In some embodiments, at least a sensor 216 may detect and monitor parameters of energy source 204 including, but not limited to, voltage, current, impedance, resistance, temperature, or the like. For example, current may be detected by using a sense resistor in series with the circuit and measuring the voltage drop across the resister, or any other suitable instrumentation and/or methods for detection and/or measurement of current. As a further example and without limitation, voltage may be detected using any suitable instrumentation or method for measurement of voltage, including methods for estimation as described in further detail below. Each of resistance, current, and voltage may alternatively or additionally be calculated using one or more relations between impedance and/or resistance, voltage, and current, for instantaneous, steady-state, variable, periodic, or other functions of voltage, current, resistance, and/or impedance, including without limitation Ohm's law and various other functions relating impedance, resistance, voltage, and current with regard to capacitance, inductance, and other circuit properties. Alternatively, or additionally, sensor 216 may be wired to an energy source 204 via, for instance, a wired electrical connection. Detecting an electrical parameter may include calculating an electrical parameter based on other sensed electrical parameters, for instance by using Ohm's law to calculate resistance and/or impedance from detected voltage and current levels.

Continuing to refer to FIG. 2, at least a sensor 216 may include, as an example and without limitation, an environmental sensor. As used herein, an environmental sensor may be used to detect ambient temperature, barometric pressure, air velocity, motion sensors which may include gyroscopes, accelerometers, inertial measurement unit (IMU), various magnetic, humidity, and/or oxygen. As another non-limiting example, sensor 216 may include a geospatial sensor. As used herein, a geospatial sensor may include optical/radar/Lidar, GPS and may be used to detect aircraft location, aircraft speed, aircraft altitude and whether the aircraft is on the correct location of the flight plan. Sensor 216 may be located inside the electric aircraft; sensor may be inside a component of the aircraft. In an embodiment, environmental sensor may sense one or more environmental conditions or parameters outside the electric aircraft, inside the electric aircraft, or within or at any component thereof, including without limitation an energy source 204, a propulsor, or the like. The environmental sensor may further collect environmental information from the predetermined landing site, such as ambient temperature, barometric pressure, air velocity, motion sensors which may include gyroscopes, accelerometers, inertial measurement unit (IMU), various magnetic, humidity, and/or oxygen. The information may be collected from outside databases and/or information services, such as Aviation Weather Information Services. Sensor 216 may detect an environmental parameter, a temperature, a barometric pressure, a location parameter, and/or other necessary measurements. Sensors 216 may detect voltage, current, or other electrical connection via a direct method or by calculation. This may be accomplished, for instance, using an analog-to-digital converter, one or more comparators, or any other components usable to detect electrical parameters using an electrical connection that may occur to any person skilled in the art upon reviewing the entirety of this disclosure. Persons skilled in the art, upon reviewing the entirety of this disclosure, will be aware of various ways to monitor the status of the system of both critical and non-critical functions.

With continued reference to FIG. 2, controller 212 may be configured to receive an electrical parameter of the energy source 204 from at least a sensor 216. The electrical parameter of energy source 204 is any electrical parameter, as described above. Controller 212 may be further configured to sense, using the electrical parameter, a usable energy capacity of the electrical energy source. Usable energy capacity, as described herein, is a capacity of power and/or energy available to deliver a load or component powered by an electrical energy source. A usable energy capacity may include a power delivery capability. As an example, and without limitation, power delivery capability may include peak power output capability, average power output capability, a duration of time during which a given power level may be maintained, and/or a time at which a given power level may be delivered, including without limitation a peak and/or average power output capability. The time is provided in terms of a measurement of time in seconds and/or other units from a given moment, a measure of time in seconds and/or other units from a given point in a flight plan, or as a given point in a flight plan, such as, without limitation, a time when power may be provided may be rendered as a time at which an aircraft arrives at a particular phase of a flight plan. As an example, and without limitation, power-production capability may indicate whether peak power may be provided at or during a landing phase of a flight plan. Power-production capability may include, as a further example and without limitation, energy delivery capability, such as a total amount of remaining energy deliverable by a given electrical energy source, as well as one or more factors such as time, temperature, or rate that may affect the total amount of energy available. As a non-limiting example, circumstances that increase output impedance and/or resistance of an electrical energy source, and thus help determine in practical terms how much energy may actually be delivered to components, may be a part of energy delivery capability.

Continuing to refer to FIG. 2, controller 212 may be further configured to utilize a machine learning model to determine a usable energy capacity needed for a flight plan. Controller 212 may receive flight plan data from a remote device, or any suitable device configured to send and receive data over a network, wired connection, or the like. In some instances, flight plan data may include, but is not limited to, a date, a time, a starting location, an ending location, one or more intermediate stops, weather data, an aircraft model, an aircraft serial number, a crew, a cargo, or any combination thereof. Flight plan data may be received from a remote device or at least a sensor 216 of power management system 200. In a non-limiting example, an aircraft model and serial number may be received from a remote device, and cargo data, weather data, and crew data may be received from at least a sensor 216. Although, different types of data may be sent from different devices and/or entities, the different types of data are all received at controller 212 and compiled to help create flight plan data.

Further, and with continued reference to FIG. 2, a flight plan may include at least a phase of a flight plan. For example, at least a phase of a flight plan may include, but are not limited to, taxiing, hovering, cruising, take-off, landing, or any combination thereof. As mentioned herein, each phase of a flight plan may have a different duration and thus use a different amount of energy. However, in some instances, a duration of at least a phase of a flight plan is not directly proportional to an amount of energy required to complete the at least a phase of the flight plan. In addition, an amount of energy required to complete at least a phase of a flight plan may depend on a current amount of usable energy available from energy source 204. That is, at least a phase of a flight plan may require less energy when available usable energy is relatively high (e.g., above fifty-percent) than when the available usable energy is low (e.g., below twenty-five percent). For example, a vertical takeoff maneuver (i.e., a vertical phase) for an aircraft may utilize more energy when available energy is relatively low in comparison to the same vertical takeoff maneuver for the aircraft with relatively high power. In addition, different styles of a similar class of maneuvers. For example, a vertical takeoff may utilize more energy than a traditional aircraft takeoff.

Still referring to FIG. 2, power management system 200 further includes graphical user interface (GUI) 220. Graphical user interface 220 may be communicatively coupled to the energy source 204 and the controller 212. As described herein, a graphical user interface is a form of user interface that allows users to interact with the controller through graphical icons and/or visual indicators. The user may, without limitation, interact with graphical user interface 120 through direct manipulation of the graphical elements. Graphical user interface 220 may be configured to display at least an element of the power-production capability of the energy source 204, as described in detail above. As an example, and without limitation, graphical user interface 220 may be displayed on any electronic device, as described herein, such as, without limitation, a computer, tablet, remote device, and/or any other visual display device.

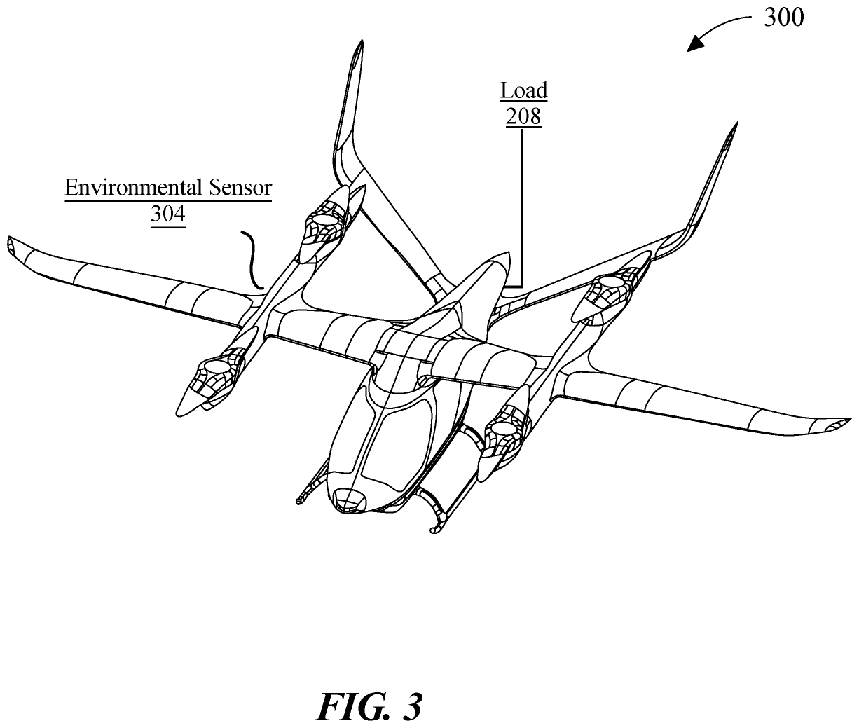

Referring now to FIG. 3, an embodiment of an electric aircraft 300 is presented in accordance with one or more embodiments of the present disclosure. Electric aircraft 300 may be an electric vertical takeoff and landing (eVTOL) aircraft. An electric aircraft may be an aircraft powered by an energy source 204. Electric aircraft 300 may include one or more wings or foils for fixed-wing or airplane-style flight and/or one or more rotors for rotor-based flight. Electric aircraft 300 may include a controller 212 communicatively and/or operatively mechanically coupled to each wing, foil, and/or each rotor, as described herein. Electric aircraft 300 may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

Still referring to FIG. 3, a number of aerodynamic forces may act upon the electric aircraft 400 during flight. Forces acting on an electric aircraft 300 during flight may include, without limitation, thrust, the forward force produced by the rotating element of the electric aircraft 300 and acts parallel to the longitudinal axis. Another force acting upon electric aircraft 300 may be, without limitation, drag, which may be defined as a rearward retarding force which is caused by disruption of airflow by any protruding surface of the electric aircraft 300 such as, without limitation, the wing, rotor, and fuselage. Drag may oppose thrust and acts rearward parallel to the relative wind. A further force acting upon electric aircraft 300 may include, without limitation, weight, which may include a combined load of the electric aircraft 300 itself, crew, baggage, and/or fuel. Weight may pull electric aircraft 300 downward due to the force of gravity. An additional force acting on electric aircraft 300 may include, without limitation, lift, which may act to oppose the downward force of weight and may be produced by the dynamic effect of air acting on the airfoil and/or downward thrust from the load 208. Lift generated by the airfoil may depend on speed of airflow, density of air, total area of an airfoil and/or segment thereof, and/or an angle of attack between air and the airfoil.

With continued reference to FIG. 3, sensors 216 may be configured to detect an electrical parameter of an energy source 204 and may be communicatively connected, as defined above, to controller 212. At least a sensor 216 may be used to detect a plurality of electrical parameters. In an embodiment, the first electrical parameter may include, without limitation, voltage, current, resistance, or any other parameter of an electrical system or circuit. The second electrical parameter may be a function of the first electrical parameter. A third electrical parameter may be calculated from a first and second electrical parameters as a delta or function. For example, the current may be calculated from the voltage measurement. Resistance may be calculated from using voltage and current measurements.

Continuing to refer to FIG. 3, at least a sensor 216 of power management system 200 may include an environmental sensor 304, wherein environmental sensor 304 may be designed and configured to detect a plurality of environmental data including, without limitation, ambient air temperature, barometric pressure, turbulence, and the like. Environmental sensor 304 may be designed and configured, without limitation, to detect geospatial data to determine the location and altitude of the electronically powered aircraft by any location method including, without limitation, GPS, optical, satellite, lidar, radar. Environmental sensor 304, as an example and without limitation, may be designed and configured to detect at a least a parameter of a motor. Environmental sensor 304 may be designed and configured, without limitation, to detect at a least a parameter of the propulsor. Sensor datum collected in flight, by at least a sensor 216 as described herein, may be transmitted to controller 212 or to a remote device, which may be any device as described herein and may be used to calculate the power output capacity of an energy source 204 and/or projected energy needs of electric aircraft during flight, as described in further detail below.

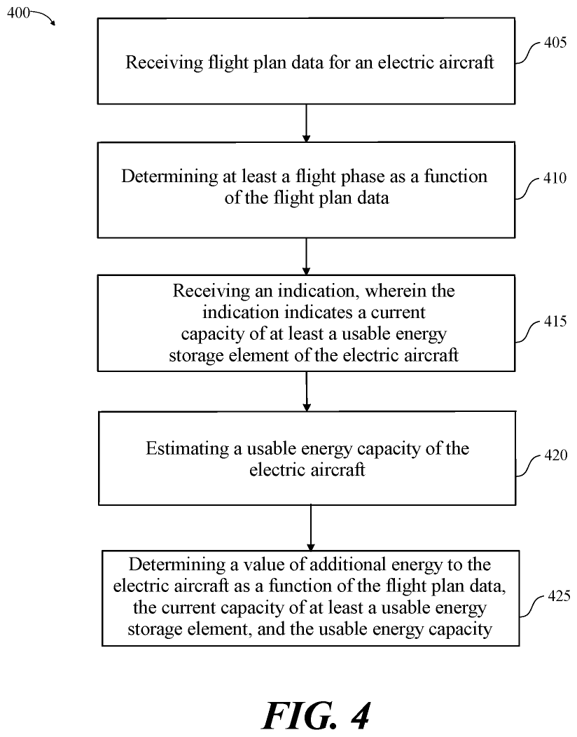

Referring now to FIG. 4, a flowchart of a method 400 of calculating anticipated energy for an electric aircraft is shown. At step 405, controller 212 may receive flight plan data 112 for electric aircraft 108. This may be implemented as described with reference to FIGS. 1-3. Fight plan data 112 may be any flight plan data described herein. In a non-limiting example, controller 212 may receive a starting location, a landing location, as well as pilot information. It should be noted that controller 212 may receive initial flight plan data prior to the departure of an electric aircraft. However, in some instances, controller 212 may receive updated flight plan data. Updated flight plan data 112 may be changes to initial flight plan data based upon data received from sensors 216. For example, weather conditions may be worse than predicted in initial flight plan data and as such, electric aircraft may require more energy to cruise. Thus, landing may occur when available energy capacity is lower than initially predicted, and as mentioned above, this may change the amount of energy needed to perform a landing maneuver.

Continuing the above discussion, and still referring to FIG. 4, method 400 may include determining at least a flight phase as function of the flight plan data 112, as shown at step 410. This may be implemented as described with reference to FIGS. 1-3. Flight plan data 112 may include at least a flight phase. At least a flight phase may include, but is not limited to, taxiing, hovering, cruising, take-off, landing, or any combination thereof. Determining at least a flight phase 116 may include compiling data received by controller 212, comparing the received data to historical flight plan data, and deciding on a flight plan as function of comparing the two datasets. However, data from at least a sensor 216, or any additional data received by controller 212 may cause flight plan data 112 to be modified to preserve enough energy to perform at least a landing maneuver for an electric aircraft that is operational. As such, it may be advantageous to use machine learning to estimate a duration and energy consumption rate of at least a flight phase.

Still referring to FIG. 4, method 400 may include receiving energy data associated with a current capacity of at least a usable energy storage element of electric aircraft 108, as shown at step 415. At least a sensor 216 may be communicatively connected to at least a usable energy storage element (e.g., energy source 104). As described herein, controller 212 may receive energy data from at least a sensor 216. In particular, controller 212 may receive energy data indicating a state of charge (SoC) of energy source 104. A state of charge (SoC) of energy source 204 may assist controller 212 in estimating a usable energy capacity of an electric aircraft.

Continuing to refer to FIG. 4, method 400 may include estimating a usable energy capacity of electric aircraft 108, as shown at step 420. This may be implemented as described with reference to FIGS. 1-3. Estimating a usable energy capacity may be done via a machine learning model. In some embodiments, a usable energy capacity machine learning algorithm may be trained using usable energy capacity training data. Usable energy capacity training data may include historical flight plan data correlated to historical usable energy capacity data. Usable energy capacity training data may be input to a usable energy capacity machine learning algorithm. A usable energy capacity machine learning model may be trained as a function of usable machine learning algorithm. Once usable energy capacity machine learning model has been trained, flight plan data 112 may be input to the usable energy capacity machine learning model and a usable energy capacity may be output as a function of the flight plan data 112 and the usable energy capacity machine learning model. As a function of usable energy capacity, controller 212 may determine a value of additional energy to add to electric aircraft 108.

Still referring to FIG. 4, method 400 may include, at step 420, estimating, for at least a flight phase 116, a duration of the at least a flight phase 116 and an energy consumption rate of the at least a flight phase. This may be implemented as described with reference to FIGS. 1-3. In some embodiments, estimating a duration of at least a flight phase and an energy consumption rate of at least a flight phase may be done using a machine learning model. Training a flight phase machine learning model may include inputting flight phase training data to a flight phase machine learning algorithm. Flight phase training data may include historical duration data and historical energy consumption data correlated to at least a flight phase. Additionally, historical duration data and historical energy consumption data may be associated with a particular aircraft, a particular pilot, a particular location, or any combination thereof. Flight phase machine learning model may be trained as a function of flight phase machine learning algorithm. As such, inputting flight plan data to a flight phase machine learning model may cause the flight phase machine learning model to output at least a flight phase as a function of the flight plan data and the flight phase machine learning model. At least a flight phase may include both a duration of the at least a flight phase as well as an energy consumption rate of the at least a flight phase. This process may be done by controller 212 or any computing device described herein. In some instances, an estimated amount of energy needed to complete at least a flight phase may be output form flight phase machine learning model. As such, it may be desirable to identify a current capacity of at least a usable energy storage capacity of an aircraft to determine whether additional energy is required to complete a flight plan having at least a flight phase. In some embodiments, an indication may be sent from at least a sensor 216 to controller 212 that a current capacity of at least a usable energy storage capacity of an aircraft is approaching a critical amount. A “critical amount” is an amount of usable energy capacity that is needed to land an operational electric aircraft. In some instances, indication may be sent in a certain time interval (e.g., 6 minutes, 10 minutes, 40 minutes, 1 hour) prior to a current capacity of at least a usable energy storage capacity of an aircraft to allow a pilot enough time to arrange a landing.

Still referring to FIG. 4, method 400 may include determining a value of additional energy to be added to the electric aircraft as a function of flight plan data 112, the current capacity of at least a usable energy storage element, and the usable energy capacity, as shown in step 425. This may be implemented as described with reference to FIGS. 1-3. “Additional energy,” as used herein, is electric energy used to supply energy source 204 and power an electric vehicle (e.g., an electric aircraft). In some embodiments, additional energy may be added to energy source 204 such that a flight plan may be completed in its entirety. In some instances, no additional energy may be added to energy source 204. This may be due to the requirements of a flight plan, financial considerations, mechanical considerations, or the like. In some instances, additional energy may be added to an electric aircraft to supply reserve fuel to the electric aircraft. As described herein, “reserve fuel” is an amount of fuel that is needed to at least land an operational electric aircraft. Electric aircraft may store reserve fuel in the same compartment as energy source 104, or in a different compartment. Reserve fuel may be the same type as energy source 104, or different. In an embodiment, determining the value of additional energy may include calculating the value of additional energy needed as a function of a decrease rate of the usable energy capacity and the usable energy capacity. A “decrease rate”, as used in this disclosure, is the rate that an energy source loses usable energy capacity over time.

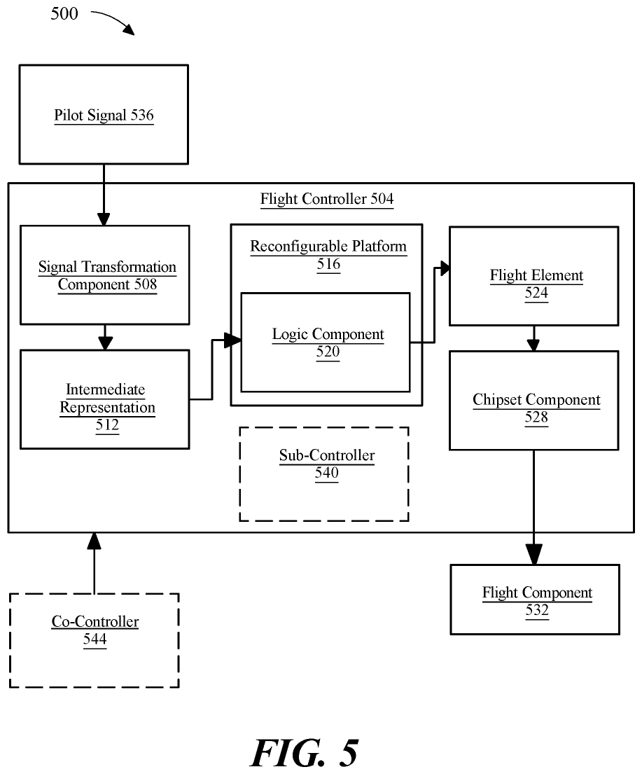

Now referring to FIG. 5, an exemplary embodiment 500 of a flight controller 504 is illustrated. As used in this disclosure a “flight controller” is a computing device of a plurality of computing devices dedicated to data storage, security, distribution of traffic for load balancing, and flight instruction. Flight controller 504 may include and/or communicate with any computing device as described in this disclosure, including without limitation a microcontroller, microprocessor, digital signal processor (DSP) and/or system on a chip (SoC) as described in this disclosure. Further, flight controller 504 may include a single computing device operating independently, or may include two or more computing device operating in concert, in parallel, sequentially or the like; two or more computing devices may be included together in a single computing device or in two or more computing devices. In embodiments, flight controller 504 may be installed in an aircraft, may control the aircraft remotely, and/or may include an element installed in the aircraft and a remote element in communication therewith.

In an embodiment, and still referring to FIG. 5, flight controller 504 may include a signal transformation component 508. As used in this disclosure a “signal transformation component” is a component that transforms and/or converts a first signal to a second signal, wherein a signal may include one or more digital and/or analog signals. For example, and without limitation, signal transformation component 508 may be configured to perform one or more operations such as preprocessing, lexical analysis, parsing, semantic analysis, and the like thereof. In an embodiment, and without limitation, signal transformation component 508 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 508 may include transforming one or more low-level languages such as, but not limited to, machine languages and/or assembly languages. For example, and without limitation, signal transformation component 508 may include transforming a binary language signal to an assembly language signal. In an embodiment, and without limitation, signal transformation component 508 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 5, signal transformation component 508 may be configured to optimize an intermediate representation 512. As used in this disclosure an “intermediate representation” is a data structure and/or code that represents the input signal. Signal transformation component 508 may optimize intermediate representation as a function of a data-flow analysis, dependence analysis, alias analysis, pointer analysis, escape analysis, and the like thereof. In an embodiment, and without limitation, signal transformation component 508 may optimize intermediate representation 512 as a function of one or more inline expansions, dead code eliminations, constant propagation, loop transformations, and/or automatic parallelization functions. In another embodiment, signal transformation component 508 may optimize intermediate representation as a function of a machine dependent optimization such as a peephole optimization, wherein a peephole optimization may rewrite short sequences of code into more efficient sequences of code. Signal transformation component 508 may optimize intermediate representation to generate an output language, wherein an “output language,” as used herein, is the native machine language of flight controller 504. For example, and without limitation, native machine language may include one or more binary and/or numerical languages.

In an embodiment, with continued reference to FIG. 5, and without limitation, signal transformation component 508 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 5, flight controller 504 may include a reconfigurable hardware platform 516. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic.

Still referring to FIG. 5, reconfigurable hardware platform 516 may include a logic component 520. As used in this disclosure a “logic component” is a component that executes instructions on output language. For example, and without limitation, logic component may perform basic arithmetic, logic, controlling, input/output operations, and the like thereof. Logic component 520 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 520 may be organized according to Von Neumann and/or Harvard architecture as a non-limiting example. Logic component 520 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 520 may include one or more integrated circuit microprocessors, which may contain one or more central processing units, central processors, and/or main processors, on a single metal-oxide-semiconductor chip. Logic component 520 may be configured to execute a sequence of stored instructions to be performed on the output language and/or intermediate representation 512. Logic component 520 may be configured to fetch and/or retrieve the instruction from a memory cache, wherein a “memory cache,” as used in this disclosure, is a stored instruction set on flight controller 504. Logic component 520 may be configured to decode the instruction retrieved from the memory cache to opcodes and/or operands. Logic component 520 may be configured to execute the instruction on intermediate representation 512 and/or output language. For example, and without limitation, logic component 520 may be configured to execute an addition operation on intermediate representation 512 and/or output language.

Still refereeing to FIG. 5. In an embodiment, and without limitation, logic component 520 may be configured to calculate a flight element 524. As used in this disclosure a “flight element” is an element of datum denoting a relative status of aircraft. For example, and without limitation, flight element 524 may denote one or more torques, thrusts, airspeed velocities, forces, altitudes, groundspeed velocities, directions during flight, directions facing, forces, orientations, and the like thereof. For example, and without limitation, flight element 524 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 524 may denote that aircraft is following a flight path accurately and/or sufficiently.

Still referring to FIG. 5, flight controller 504 may include a chipset component 528. As used in this disclosure a “chipset component” is a component that manages data flow. In an embodiment, and without limitation, chipset component 528 may include a northbridge data flow path, wherein the northbridge dataflow path may manage data flow from logic component 520 to a high-speed device and/or component, such as a RAM, graphics controller, and the like thereof. In another embodiment, and without limitation, chipset component 528 may include a southbridge data flow path, wherein the southbridge dataflow path may manage data flow from logic component 520 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 528 may manage data flow between logic component 520, memory cache, and a flight component 532. As used in this disclosure a “flight component” is a portion of an aircraft that can be moved or adjusted to affect one or more flight elements. For example, flight component 432 may include a component used to affect the aircrafts' roll and pitch which may comprise one or more ailerons. As a further example, flight component 532 may include a rudder to control yaw of an aircraft. In an embodiment, chipset component 528 may be configured to communicate with a plurality of flight components as a function of flight element 524. For example, and without limitation, chipset component 528 may transmit to an aircraft rotor to reduce torque of a first lift propulsor and increase the forward thrust produced by a pusher component to perform a flight maneuver.

In an embodiment, and still referring to FIG. 5, a remote device and/or FPGA may generate autonomous function as a function of an autonomous machine-learning model. As used in this disclosure a “remote device” is an external device to flight controller 504. As used in this disclosure an “autonomous function” is a mode and/or function of flight controller 504 that controls aircraft automatically. As used in this disclosure an “autonomous machine-learning model” is a machine-learning model to produce an autonomous function output given flight element 524 and a pilot signal 536 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 536 may denote that a pilot is controlling and/or maneuvering ailerons, wherein the pilot is not in control of the rudders and/or propulsors. In an embodiment, pilot signal 536 may include an implicit signal and/or an explicit signal. For example, and without limitation, pilot signal 536 may include an explicit signal, wherein the pilot explicitly states there is a lack of control and/or desire for autonomous function. As a further non-limiting example, pilot signal 536 may include an explicit signal directing flight controller 504 to control and/or maintain a portion of aircraft, a portion of the flight plan, the entire aircraft, and/or the entire flight plan. As a further non-limiting example, pilot signal 536 may include an implicit signal, wherein flight controller 504 detects a lack of control such as by a malfunction, torque alteration, flight path deviation, and the like thereof. In an embodiment, and without limitation, pilot signal 536 may include one or more explicit signals to reduce torque, and/or one or more implicit signals that torque may be reduced due to reduction of airspeed velocity. In an embodiment, and without limitation, pilot signal 536 may include one or more local and/or global signals. For example, and without limitation, pilot signal 536 may include a local signal that is transmitted by a pilot and/or crew member. As a further non-limiting example, pilot signal 536 may include a global signal that is transmitted by air traffic control and/or one or more remote users that are in communication with the pilot of aircraft. In an embodiment, pilot signal 536 may be received as a function of a tri-state bus and/or multiplexor that denotes an explicit pilot signal should be transmitted prior to any implicit or global pilot signal.

Continuing to refer to FIG. 5. In some embodiments, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 524. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 504 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 504 will control the ailerons and/or rudders. As used in this disclosure “non-autonomous mode” is a mode that denotes a pilot will control aircraft and/or maneuvers of aircraft in its entirety.

Still referring to FIG. 5, autonomous machine-learning model may include one or more autonomous machine-learning processes such as supervised, unsupervised, or reinforcement machine-learning processes that flight controller 504 and/or a remote device may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 5, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 5, flight controller 504 may receive an autonomous function from a remote device and/or FPGA that utilizes one or more autonomous machine learning processes as described above. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 504. Remote device and/or FPGA may transmit a signal, bit, datum, or parameter to flight controller 504 that at least relates to autonomous function. Additionally or alternatively, autonomous machine-learning model may include one or more autonomous machine-learning processes that a field-programmable gate array (FPGA) may or may not use in the generation of autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 504 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 5, flight controller 504 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 5, flight controller 504 may include, but is not limited to, for example, a cluster of flight controllers in a first location and a second flight controller or cluster of flight controllers in a second location. Flight controller 504 may include one or more flight controllers dedicated to data storage, security, distribution of traffic for load balancing, and the like. Flight controller 504 may be configured to distribute one or more computing tasks as described below across a plurality of flight controllers, which may operate in parallel, in series, redundantly, or in any other manner used for distribution of tasks or memory between computing devices. For example, and without limitation, flight controller 504 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 5, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 532. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 5, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 504. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 512 and/or output language from logic component 520, wherein output language may include one or more analog-to-digital conversions, low bit rate transmissions, message encryptions, digital signals, binary signals, logic signals, analog signals, and the like thereof described above in detail.

Still referring to FIG. 5, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 5, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 5, flight controller 504 may also be implemented using a “shared nothing” architecture in which data is cached at the worker, in an embodiment, this may enable scalability of aircraft and/or computing device. Flight controller 504 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers.

Still referring to FIG. 5, flight controller may include a sub-controller 540. As used in this disclosure a “sub-controller” is a controller and/or component that is part of a distributed controller as described above; for instance, flight controller 504 may be and/or include a distributed flight controller made up of one or more sub-controllers. For example, and without limitation, sub-controller 540 may include any controllers and/or components thereof that are similar to distributed flight controller and/or flight controller as described above. Sub-controller 540 may include any component of any flight controller as described above. Sub-controller 540 may be implemented in any manner suitable for implementation of a flight controller as described above. As a further non-limiting example, sub-controller 540 may include one or more processors, logic components and/or computing devices capable of receiving, processing, and/or transmitting data across the distributed flight controller as described above. As a further non-limiting example, sub-controller 540 may include a controller that receives a signal from a first flight controller and/or first distributed flight controller component and transmits the signal to a plurality of additional sub-controllers and/or flight components.

Still referring to FIG. 5, flight controller may include a co-controller 544. As used in this disclosure a “co-controller” is a controller and/or component that joins flight controller 504 as components and/or nodes of a distributer flight controller as described above. For example, and without limitation, co-controller 544 may include one or more controllers and/or components that are similar to flight controller 504. As a further non-limiting example, co-controller 544 may include any controller and/or component that joins flight controller 504 to distributer flight controller. As a further non-limiting example, co-controller 544 may include one or more processors, logic components and/or computing devices capable of receiving, processing, and/or transmitting data to and/or from flight controller 504 to distributed flight control system. Co-controller 544 may include any component of any flight controller as described above. Co-controller 544 may be implemented in any manner suitable for implementation of a flight controller as described above.

In an embodiment, and with continued reference to FIG. 5, flight controller 504 may be designed and/or configured to perform any method, method step, or sequence of method steps in any embodiment described in this disclosure, in any order and with any degree of repetition. For instance, flight controller 504 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

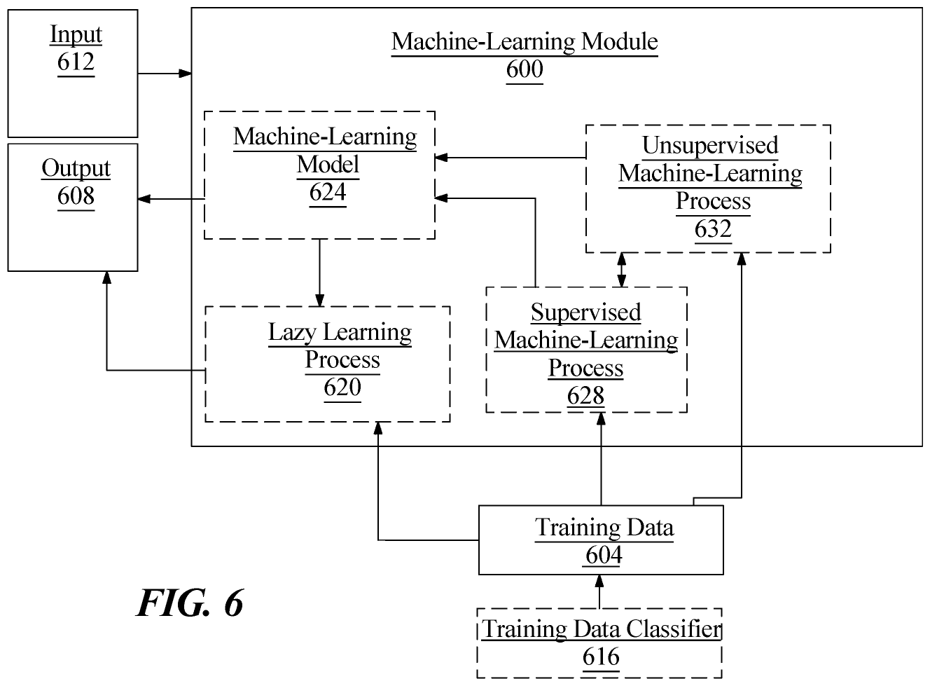

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure. As a non-limiting illustrative example flight path data may be input, wherein an output may be an usable energy capacity.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 600 may generate a classifier using a classification algorithm, defined as a process whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to sub-categories of flight elements such as torques, forces, thrusts, directions, and the like thereof.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

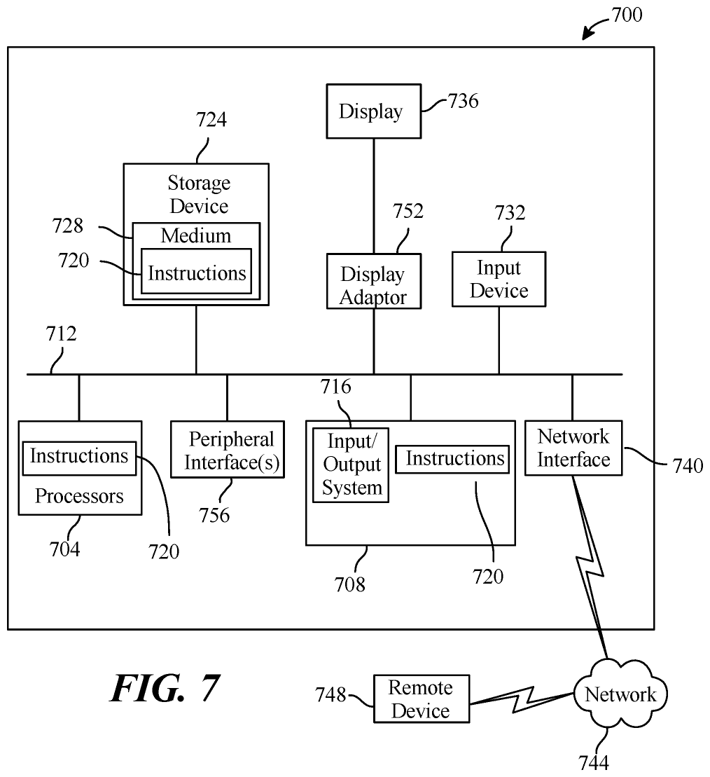

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method comprising:
determining, by a processor, a usable energy capacity of a storage element of an electric aircraft as a function of flight plan data including a flight plan; and
determining, by the processor, an amount of additional energy to be added to the electric aircraft as a function of: the flight plan data, a current capacity of the storage element, the usable energy capacity of the storage element, and a decrease rate of the usable energy capacity.

2. The method of claim 1, wherein the flight plan data comprises data specific to a particular pilot.

3. The method of claim 1, wherein the amount of additional energy further includes determining the amount of additional energy as a function of an identified pilot.

4. The method of claim 1, wherein estimating the usable energy capacity of the storage element of the electric aircraft further includes estimating a duration of a flight phase and an energy consumption rate of the flight phase.

5. The method of claim 1, wherein the electric aircraft is an electric vertical takeoff and landing (eVTOL) aircraft that includes a vertical flight phase.

6. The method of claim 4, wherein estimating the duration of a flight phase includes:
executing a flight phase machine learning model using the flight plan data as input.

7. The method of claim 4, wherein estimating the energy consumption rate comprises:
executing an energy consumption machine learning model using the flight plan data as input.

8. (canceled)

9. The method of claim 1, wherein determining the amount of additional energy further comprises:
executing an additional energy machine learning model using the flight plan data as input.

10. The method of claim 1, wherein determining the amount of the additional energy further includes determining the amount of additional energy as a function of an immediately preceding flight plan of the electric aircraft.

11. An apparatus comprising at least a processor and a memory communicatively connected to the at least a processor, the memory containing instructions to:
determine a usable energy capacity a storage element of an electric aircraft as a function of flight plan data including a flight plan; and
determine an amount of additional energy to be added to the electric aircraft as a function of: the flight plan data, a current capacity of the storage element, the usable energy capacity, and a decrease rate of the usable energy capacity.

12. The apparatus of claim 11, wherein the flight plan data comprises data specific to a particular pilot.

13. The apparatus of claim 12, wherein the amount of additional energy further includes determining the amount of additional energy as a function of an identified pilot.

14. The apparatus of claim 11, wherein the memory contains instructions to further configure the at least a processor to estimate a duration of a flight phase and an energy consumption rate of the flight phase.

15. The apparatus of claim 14, wherein the electric aircraft is an electric vertical takeoff and landing (eVTOL) aircraft that includes a vertical phase.

16. The apparatus of claim 14, wherein estimating the duration of a flight phase further includes:
executing a flight phase machine learning model using the flight plan data as input.

17. The apparatus of claim 14, wherein estimating the energy consumption rate comprises:
executing an energy consumption machine learning model using the flight plan data as input.

18. (canceled)

19. The apparatus of claim 11, wherein determining the amount of additional energy comprises:
executing an additional energy machine learning model using the flight plan data as input.

20. The apparatus of claim 11, wherein determining the amount of the additional energy is a function of an immediately preceding flight plan of the electric aircraft.
